(19) United States
(12) Patent Application Publication
(10) Pub. No.: US 2018/0166839 A1
(43) Pub. Date: Jun. 14, 2018

(54) POWER DISTRIBUTION UNIT AND ELECTRONIC DEVICE USING THE SAME

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventor: CHIEN-CHUNG YEN, New Taipei (TW)

(21) Appl. No.: 15/458,719

(22) Filed: Mar. 14, 2017

(30) Foreign Application Priority Data
Dec. 9, 2016 (CN) 201611128887.8

(51) Int. Cl. H01R 25/00; H02B 1/32; H02B 1/056; H01R 13/70; H01R 27/02

(52) U.S. Cl. CPC H01R 25/006; H02B 1/32; H01R 27/02; H01R 13/70; H02B 1/056

(57) ABSTRACT

A power distribution unit includes a chassis and at least one power distribution module. The chassis includes a plurality of side plates. Each of the at least one power distribution module includes a control unit and a plurality of power distribution sockets electrically connected to the control unit. At least one of the plurality of plates defines an accommodating groove to receive the at least one power distribution module. An electronic device using the power distribution unit is further disclosed.

### FIELD

The subject matter herein generally relates to a power distribution unit and electronic device using the power distribution unit.

### BACKGROUND

Power distribution units commonly divide incoming power into a number of branch circuits. The branch circuits supply power to various equipment, such as servers, routers, and hubs.

### BRIEF DESCRIPTION OF THE DRAWINGS

Implementations of the present technology will now be described, by way of example only, with reference to the attached figures.

FIG. 1 is an isometric view of an exemplary embodiment of a power distribution unit.

FIG. 2 is an exploded view of the power distribution unit of FIG. 1.

FIG. 3 is a circuit diagram of the power distribution unit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

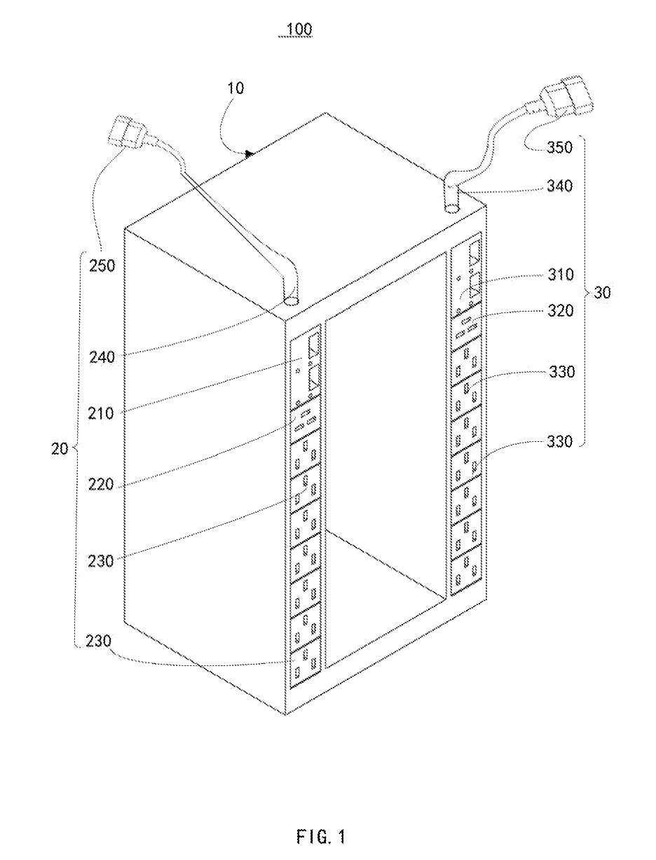

FIGS. 1 to 3 illustrate an power distribution unit 100 in an exemplary embodiment.

As illustrated in FIG. 1, the power distribution unit 100 can include a chassis 10, a first power distribution module 20, and a second power distribution module 30. The first power distribution module 20 and the second power distribution module 30 are mounted to the chassis 10.

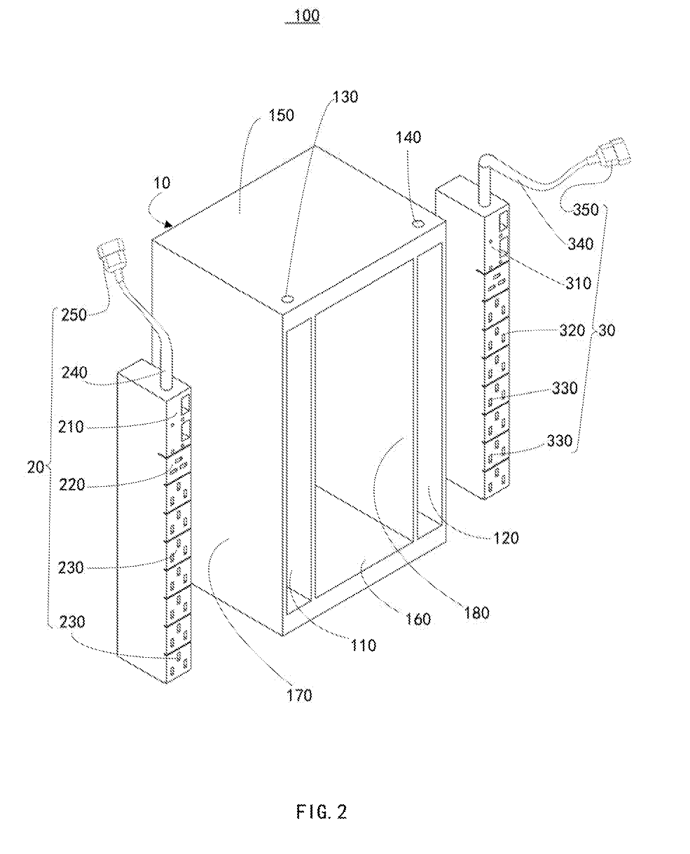

As illustrated in FIG. 2, the chassis 10 can include a bottom plate 160, a top plate 150 parallel to the bottom plate 160, a first side plate 170, and a second side plate 180. The first side plate 170 and the second side plate 180 are perpendicularly connected between the bottom plate 160 and the top plate 150. The first side plate 170 and the second side plate 180 are parallel to each other.

The first side plate 170 defines a first accommodating groove 110. The second side plate 180 defines a second accommodating groove 120. The first power distribution module 20 is received in the first accommodating groove 100. The second power distribution module 30 is received in the second accommodating groove 120.

Each of the first power distribution module 20 and the second power distribution module 30 can include a control unit and a plurality of power distribution sockets electrically connected to the control unit. For example, the control unit can be a circuit breaker. The plurality of power distribution sockets can be of the same specification, or the plurality of power distribution sockets can be of different specifications.

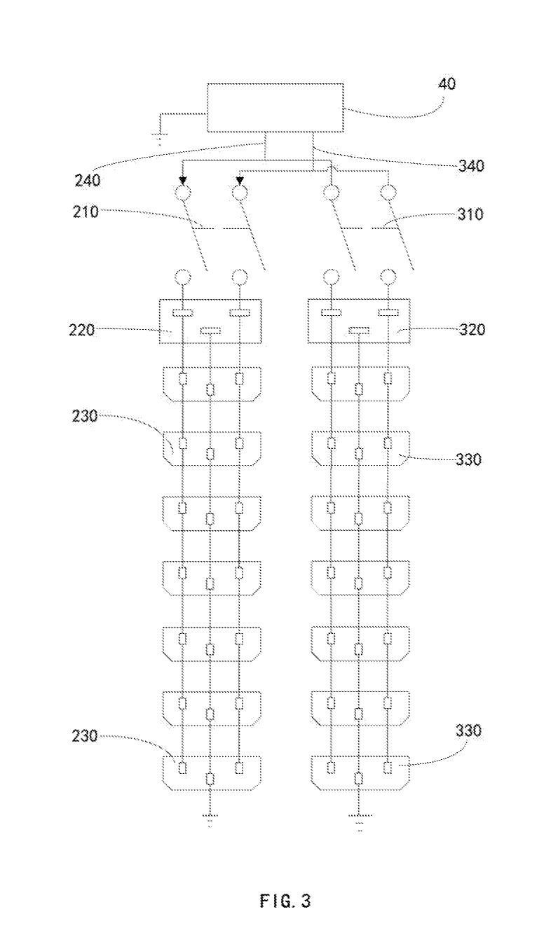

As illustrated in FIGS. 2 and 3, The first power distribution module 20 can include a first circuit breaker 210, a first power distribution socket 220, a plurality of second power distribution sockets 230, a first plug (not explicitly shown), and a first power line 240. The first power distribution socket 220 and the second power distribution sockets 230 are electrically connected to an output end of the first circuit breaker 210. The first plug is electrically connected to an input end of the first circuit breaker 210 through the first power line 240.

The second power distribution module 30 can include a second circuit breaker 310, a third power distribution socket 320, a plurality of fourth power distribution sockets 330, a second plug (not explicitly shown), and a second power line 340. The third power distribution socket 220 and the fourth power distribution sockets 330 are electrically connected to an output end of the second circuit breaker 310. The second plug is electrically connected to an input end of the second circuit breaker 310 through the second power line 340.

The top plate defines a first through hole 130 interconnecting with the first accommodating groove 110 and a second through hole 140 interconnecting with the second accommodating groove 120. The power distribution unit can further include a power cable (not explicitly shown) connected to an external power source 40. The first power line 240 and the first plug pass through the first through hole 130 to connect to the power cable, the second power line 340 and the second plug pass through the second through hole 140 to connect to the power cable.

Each of the first circuit breaker 210 and the second circuit breaker 310 can be switched on or off. The first power distribution socket 220, the second power distribution sockets 230, the third power distribution socket 320, and the fourth power distribution sockets 330 are thereby controlled to switch between a power supply state and a circuit breaker state.

In at least one exemplary embodiment, the first power distribution module 20 and the second power distribution module 30 are detachably received in the first accommodating groove 110 and the second accommodating groove 120, respectively. The first power distribution socket 220 and the third power distribution socket 320 can be C19-type. The second power distribution socket 230 and the fourth power distribution socket 330 can be C13-type. Each of the C19-type power distribution sockets and the C13-type power distribution sockets can be modular to make it easier to adjust the number or position of the C19-type power distribution sockets and the C13-type power distribution sockets according to electronic components in the chassis 10.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

1. A power distribution unit comprising:
a chassis comprising a plurality of side plates;
at least one power distribution module comprising:
a control unit; and
a plurality of power distribution sockets electrically connected to the control unit;
wherein at least one of the plurality of side plates defines an accommodating groove to receive the at least one power distribution module.

2. The power distribution unit of claim 1, wherein the plurality of power distribution sockets is of the same specification.

3. The power distribution unit of claim 1, wherein the plurality of power distribution sockets is of different specifications.

4. The power distribution unit of claim 3, wherein the chassis comprises:
a bottom plate;
a top plate parallel to the bottom plate; and
a first side plate and a second side plate perpendicularly connected between the bottom plate and the top plate;
wherein the first side plate and the second side plate are parallel to each other.

5. The power distribution unit of claim 4, wherein the top plate defines at least one through hole interconnecting with the accommodating groove.

6. The power distribution unit of claim 5, wherein the control unit is a circuit breaker, an input end of the circuit breaker is connected to a plug with power lines, the power lines and the plug pass through the at least one through hole to be connected to an external power source, an output end of the circuit breaker is electrically connected to the plurality of power distribution sockets.

7. The power distribution unit of claim 6, wherein the first side plate defines a first accommodating groove, the second side plate defines a second accommodating groove; a first power distribution module is received in the first accommodating groove, a second power distribution module is received in the second accommodating groove.

8. The power distribution unit of claim 7,
wherein the first power distribution module comprises:
a first circuit breaker;
at least one first power distribution socket and a plurality of second power distribution sockets, wherein the at least one first power distribution socket and the plurality of second power distribution sockets are electrically connected to an output end of the first circuit breaker; and
a first plug and a first power line, wherein the first plug is electrically connected to an input end of the circuit breaker through the first power line;
wherein the second power distribution module comprises:
a second circuit breaker;
at least one third power distribution socket and a plurality of fourth power distribution sockets, wherein the at least one third power distribution socket and the plurality of fourth power distribution sockets are electrically connected to an output end of the second circuit breaker; and
a second plug and a second power line, wherein the second plug is electrically connected to an input end of the circuit breaker through the second power line.

9. The power distribution unit of claim 8, wherein the top plate defines a first through hole interconnecting with the first accommodating groove and a second through hole interconnecting with the second accommodating groove; the power distribution unit further comprises a power cable connected to the external power source, the first power line and the first plug pass through the first through hole to connect to the power cable, the second power line and the second plug pass through the second through hole to connect to the power cable.

10. The power distribution unit of claim 9, wherein the first power distribution socket and the third power distribution socket are C19-type, the second power distribution socket and the fourth power distribution socket are C13-type.

11-20. (canceled)
